(19) United States
(12) Patent Application Publication
(10) Pub. No.: US 2016/0110745 A1
(43) Pub. Date: Apr. 21, 2016

(54) SYSTEM AND METHOD FOR FACILITATING STRATEGIC INSTALLATION OF CHARGING PORTS FOR ELECTRIC VEHICLES

(71) Applicant: MASTERCARD INTERNATIONAL INCORPORATED, Purchase, NY (US)

(72) Inventors: Marianne Iannace, North Salem, NY (US); Edward M. Lee, Scarsdale, NY (US)

(21) Appl. No.: 14/515,405

(22) Filed: Oct. 15, 2014

(51) Int. Cl. G06Q 30/02; B60L 11/18; G06Q 20/18

(52) U.S. Cl. CPC G06Q 30/0205; G06Q 20/18; B60L 11/1848

(57) ABSTRACT

Methods and systems facilitate strategic installation of charging ports for charging electric vehicles. Transaction information associated with financial transactions executed using payment cards is analyzed to determine identification (ID) proxies for consumers, charging locations, and reference locations. Predictors are used to determine outputs that facilitate strategic installation of charging ports.

### BACKGROUND

The demand for charging ports outside of the home has increased with recent increases in electric vehicle ownership. Charging ports for charging electric vehicles often are installed at mass transit parking lots (e.g., associated with train stations or bus stations) or at a small number of select places of business. These charging ports often are not strategically placed in various locations to satisfy demand.

### SUMMARY

Embodiments of the methods and systems described herein may be configured to utilize transaction information associated with payment card transactions to facilitate strategic installation of charging ports. For example, transaction information may be analyzed to determine target locations for installing additional charging ports, determining optimal numbers of charging ports for a particular location, and/or the like.

In embodiments, a system facilitates strategic installation of charging ports for electric vehicles. The system may include a first charging port, at a charging location, configured to provide electricity for charging an electric vehicle and a point-of-sale (POS) device, disposed at the first charging location and associated with the first charging port. The POS device may be configured to extract payment card information from payment cards and to generate a first set of transaction information that includes the payment card information, where each payment card is capable of facilitating a transaction originating at the POS device. The system may also include a payment processing system configured to receive the first set of transaction information from the POS device; and a processing server configured to receive the transaction information from the payment processing system.

In embodiments, the processing server includes a storage component containing (1) the first set of transaction information, and (2) a second set of transaction information. The second set of transaction information may include information associated with a second set of transactions completed using the payment cards, where each transaction of the second set of transactions originates at a location different from the first charging location. The processing server may also include an identification (ID) proxy component configured to develop ID proxies, where each of the ID proxies corresponds to one of the payment cards such that there is a one-to-one correspondence between the ID proxies and the payment cards; a reference location component configured to determine reference locations, each corresponding to one of the ID proxies; and a predictor configured to determine an output used to facilitate strategic installation of a second charging port, where the output is based on at least one of the first set of transaction information, the second set of transaction information, and the reference locations.

In embodiments, a method facilitates strategic installation of charging ports for electric vehicles. Embodiments of the method include identifying a first charging port at a charging location. A POS device may be disposed at the charging location and may be associated with the first charging port. In embodiments, the POS device is configured to extract payment card information from payment cards and to generate a first set of transaction information that includes the payment card information, where each payment card is capable of facilitating a transaction originating at the POS device. Embodiments of the method further include referencing the first set of transaction information; developing identification (ID) proxies, where each of the ID proxies corresponds to one of the payment cards such that there is a one-to-one correspondence between the ID proxies and the payment cards; and determining reference locations, each corresponding to one of the ID proxies.

The method may also include referencing a second set of transaction information, where the second set of transaction information includes information associated with a second set of transactions completed using the payment cards, each transaction of the second set of transactions originating at a location different from the charging location. In embodiments, the method includes generating, based on the reference locations and the second set of transaction information, a spending density map comprising indications, for each of the ID proxies, of spending behaviors in a geographic region; and determining, using the spending density map, a target location for installation of a second charging port.

In embodiments, another system facilitates strategic installation of charging ports for electric vehicles. Embodiments of the system include a retention device having executable instructions embodied thereon; and a processor configured to execute instructions to instantiate components. The components may include an input/output (I/O) component configured to receive a first set of transaction information from a point-of-sale (POS) device, the POS device being associated with a first charging port at a charging location, the POS device being configured to extract payment card information from payment cards and to generate a first set of transaction information that includes the payment card information, where each payment card is capable of facilitating a transaction originating at the POS device; and a storage component configured to store (1) the first set of transaction information, and (2) a second set of transaction information, where the second set of transaction information comprises information associated with a second set of transactions completed using the payment cards. In embodiments, each transaction of the second set of transactions originates at a location different from the charging location.

Embodiments of the system further include an identification (ID) proxy component configured to develop ID proxies, where each of the ID proxies corresponds to one of the payment cards such that there is a one-to-one correspondence between the ID proxies and the payment cards; a reference location component configured to determine reference locations, each corresponding to one of the ID proxies; and a predictor configured to determine an output used to facilitate strategic installation of a second charging port, where the output is based on at least one of the first set of transaction information, the second set of transaction information, and the reference locations.

In embodiments, another method facilitates strategic installation of charging ports for electric vehicles. Embodiments of the method include identifying a charging port. A POS device may be associated with the charging port, the POS device being configured to extract payment card information from payment cards and to generate a set of transaction information that includes the payment card information, where each payment card is capable of facilitating a transaction originating at the POS device. Embodiments of the method may also include referencing the set of transaction information; developing identification (ID) proxies, where each of the ID proxies corresponds to one of the payment cards such that there is a one-to-one correspondence between the ID proxies and the payment cards; determining a plurality of metrics associated with the set of transaction information; and determining, based on the plurality of metrics, a target number of ports for the charging location.

### BRIEF DESCRIPTION OF THE DRAWINGS

FIG. 1 is a block diagram illustrating an operating environment and operational aspects in accordance with embodiments disclosed and otherwise contemplated herein;

FIG. 2 is a flow diagram depicting an illustrative method for facilitating strategic installation of charging ports for electric vehicles in accordance with embodiments disclosed and otherwise contemplated herein;

FIG. 3 is a flow diagram depicting another illustrative method for facilitating strategic installation of charging ports for electric vehicles in accordance with embodiments disclosed and otherwise contemplated herein;

FIG. 4 depicts a conceptual representation of a spending density map in accordance with embodiments disclosed and otherwise contemplated herein; and

FIG. 5 is a flow diagram depicting an illustrative method for determining a target location for installation of a charging port for electric vehicles in accordance with embodiments disclosed and otherwise contemplated herein.

While the present disclosure is amenable to various modifications and alternative forms, specific embodiments have been shown by way of example in the drawings and are described in detail below. The present disclosure, however, is not limited to the particular embodiments described. On the contrary, the present disclosure is intended to cover all modifications, equivalents, and alternatives falling within the ambit of the present disclosure as defined by the appended claims.

Although the term “block” may be used herein to connote different elements illustratively employed, the term should not be interpreted as implying any requirement of, or particular order among or between, various steps disclosed herein unless and except when explicitly referring to the order of individual steps.

### DETAILED DESCRIPTION

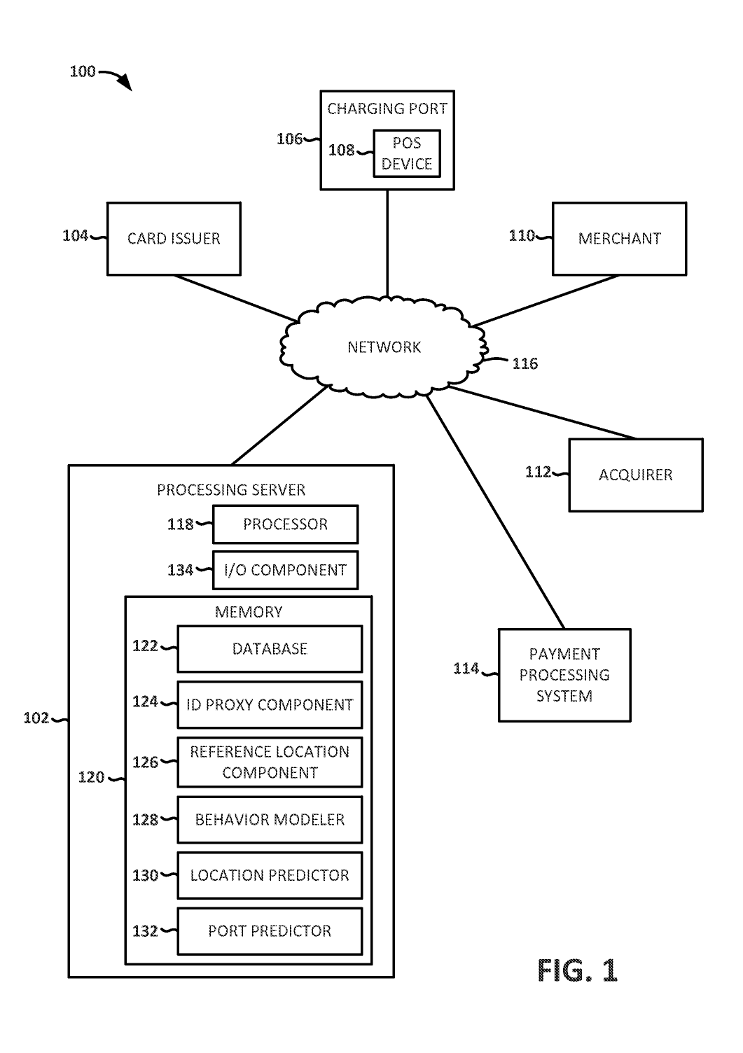

FIG. 1 depicts an example of an operating environment 100 in accordance with embodiments disclosed and otherwise contemplated herein. In embodiments, the operating environment 100 may be, include, or be included in, a scalable, distributed server system configured to perform server-based tasks. As shown in FIG. 1, the operating environment 100 includes a processing server 102 that is configured to facilitate strategic installation of charging ports. The processing server 102 may facilitate strategic installation of charging ports by performing analyses to identify locations at which charging ports should be installed and/or to determine target numbers of charging ports to be installed at charging locations.

As shown in FIG. 1, the operating environment 100 includes a card issuer 104 that issues a payment card to a cardholder (not shown). For example, the card issuer 104 may be a bank or credit union. A payment card may include any type of card used for facilitating financial transactions such as, for example, a debit card, a credit card, a gift card, and/or the like. The operating environment 100 also includes a charging port 106, which may be any type of station, device, or system configured to provide electricity for charging an electric vehicle. For example, the charging port 106 may include an electrical socket configured to receive a plug that is electrically coupled to a battery of an electric vehicle so as to recharge the battery. A point-of-sale (POS) device 108 is associated with the charging port 106. The POS device 108 may be any type of device configured to facilitate execution of a financial transaction to enable a consumer to access electricity provided by the charging port 106. The POS device 108 may include a payment card reader, a computer, a bill acceptor, and/or the like. In embodiments, the POS device 108 is configured to extract payment card information from payment cards used to complete transactions originating at the POS device 108 and to generate transaction information that includes the payment card information.

As shown in FIG. 1, the environment also includes a merchant 110. The merchant 110 may include any type of entity that provides a product and/or a service in exchange for payment. For example, the merchant 110 may include a retail store, a wholesale distributor, a service provider, an online store, and/or the like. In embodiments, the charging port 106 may be provided, maintained, and/or serviced by a merchant 110. The merchant 110 may engage in a financial relationship with an acquiring bank (referred to herein as an “acquirer”) 112. The acquirer 112 may provide banking services, loan services, and/or the like. The operating environment 100 depicted in FIG. 1 also includes a financial transaction processing agency (referred to herein as a “payment processing system”) 114. The payment processing system 114 may be any type of processing system configured to process financial transactions, for example as part of a traditional four-party transaction processing system such as MasterCard®.

Although only one of each of the processing server 102, the card issuer 104, the charging port 106, the POS device 108, the merchant 110, the acquirer 112, and the payment processing system 114 is illustrated in FIG. 1, it should be understood that an illustrative operating environment 100 may include any number of each of these components and/or various combinations thereof. Additionally, each of the components 102, 104, 106, 108, 110, 112, and 114 may be configured to communicate with one or more other components 102, 104, 106, 108, 110, 112, or 114 via a network 116. The network 116 may be, or include, any number of different types of communication networks such as, for example, a bus network, a short messaging service (SMS), a local area network (LAN), a wireless LAN (WLAN), a wide area network (WAN), the Internet, a P2P network, custom-designed communication or messaging protocols, and/or the like. The network 116 may include a combination of multiple networks.

In operation, the cardholder engages in a financial transaction with, e.g., the merchant 110. The financial transaction may be an in-person financial transaction (e.g., at a physical location of the merchant 110) or may be performed remotely, such as via telephone, mail, or the Internet (e.g., a “card not present” transaction). The financial transaction may be processed by the payment processing system 114. For example, the merchant 110 may submit transaction information associated with the financial transaction to the acquirer 112, which may submit an authorization request to the payment processing system 114. The payment processing system 114 may contact the card issuer 104 for approval of the transaction, which may subsequently be forwarded on to the acquirer 112 and/or the merchant 110. The payment processing system 114 may identify and store transaction information associated with each financial transaction processed. Transaction information may include, for example, payment method, transaction amount, merchant identification, Merchant Category Code (MCC), transaction location, merchant industry, transaction time and date, and/or the like.

In embodiments, the transaction information may be used by the processing server 102 to facilitate strategic installation of charging ports for electric vehicles. The processing server 102 may receive transaction information from the payment processing system 114 and store the received information in a database 122 (also referred to as a storage component). In embodiments, the transaction information received and stored in the database 122 may not include any personally identifiable information (PII), yet in other embodiments, the transaction information may contain hashed or encrypted PII, for example if authorized by the cardholder. In embodiments, the processing server 102 and the payment processing system 114 may be, or include, a single organizational entity. That is, for example, the processing server 102 may be hosted and/or maintained by the payment processing system 114. The processing server 102 may also receive transaction information from the card issuer 104 (e.g., information about the cardholder) and/or the acquirer 112 (e.g., information about the merchant 110). In embodiments, the payment processing system 114 and the acquirer 112 may be the same entity (e.g., in the case of a three-party system).

The database 122 may be configured to store transaction information corresponding to a number of financial transactions. For example, in embodiments, the database 122 contains a first set of transaction information, the first set of transaction information including information associated with a first set of payment card transactions, where each transaction of the first set of transactions originates at a charging location corresponding to the charging port 106. The database 122 may also contain a second set of transaction information, the second set of transaction information including information associated with a second set of payment card transactions completed using each of the payment cards, where each transaction of the second set of transactions originates at a location different than the charging location. For example, each transaction of the second set of transactions may originate at a merchant 110, unrelated to a charging port 106.

As shown in FIG. 1, the processing server 102 includes an identification (ID) proxy component 124. The ID proxy component 124 may be configured to develop a number of ID proxies, each of the ID proxies corresponding to one of a number of payment cards such that there is a one-to-one correspondence between the ID proxies and the payment cards (i.e., each ID proxy is associated with a single payment card). ID proxies may be used to represent, for example, customers that drive electric vehicles. Because personally identifiable information associated with payment cards is not often available to the payment processing system 114 (and, thus, the processing server 102), ID proxies may be used to represent the cardholders. That is, for example, each payment card may represent a customer that drives (or at least potentially drives) an electric vehicle. Accordingly, in embodiments, the payment card number itself may be used as the ID proxy, an arbitrary identifier may be assigned as the ID proxy, and/or the like.

A reference location component 126 may be configured to determine a number of reference locations, each corresponding to one of the ID proxies. A reference location refers to a geographic location and/or region that represents a center of spending activity associated with an ID proxy. That is, for example, a reference location associated with a particular ID proxy may represent a corresponding customer's residential address, work address, and/or the like. In embodiments, the reference location component 126 is configured to determine reference locations by receiving residence locations from a payment card issuer, where each of the residence locations includes at least a portion of an address of a cardholder. In that case, for example, a reference location may be the residential or work address, or a portion thereof (e.g., a postal code, a street name, a block number, or a house number).

In some implementations, residence information may not be available to the processing server 102 and, in which case, the reference location component 126 may be configured to determine reference locations by analyzing a set of spending behaviors associated with the ID proxies. The reference location component 126 may be configured to develop reference location proxies based on the analyzed spending behaviors, where the reference location proxies are estimates of reference locations and, for the purposes of analysis, may be treated as reference locations. Any number of different techniques may be used to develop reference location proxies based on spending behaviors, including, but not limited to, aspects of embodiments of the techniques disclosed in U.S. Publication No. 2013/0024242, to Villars et al., entitled “PROTECTING PRIVACY IN AUDIENCE CREATION,” filed on Apr. 3, 2012; and U.S. Publication No. 2014/0180767, to Villars, entitled “METHOD AND SYSTEM FOR ASSIGNING SPENDING BEHAVIORS TO GEOGRAPHIC AREAS,” filed on Dec. 20, 2012. Both of the aforementioned publications are hereby expressly incorporated herein by reference, in their entireties, for all purposes.

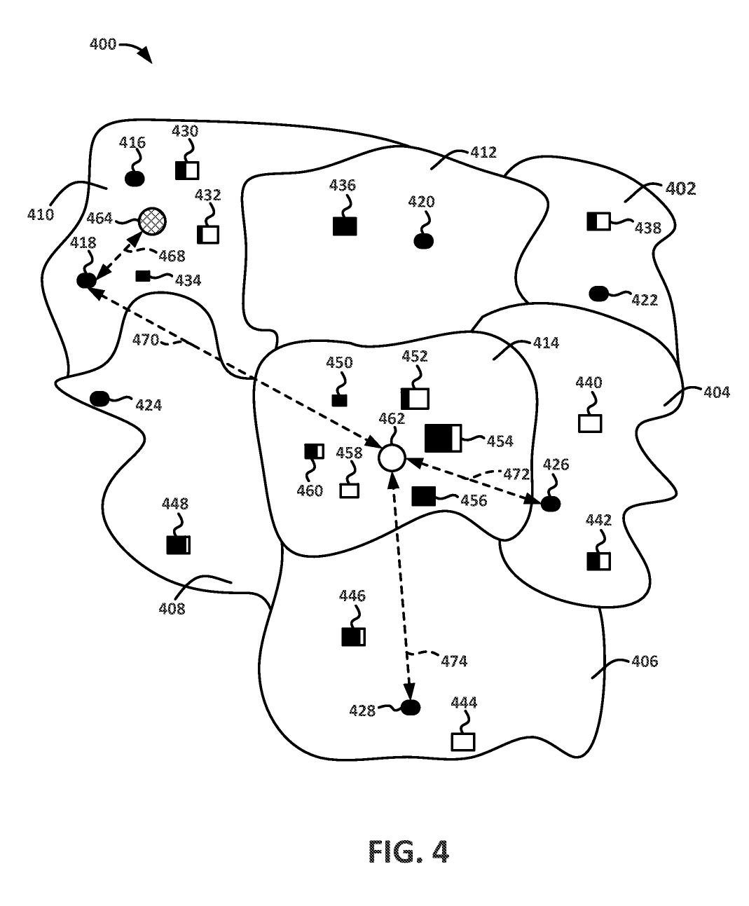

As shown in FIG. 1, the processing server 102 also includes a behavior modeler 128, which may be configured to work with (or be called, e.g., as a function, by) the reference location component 126 to facilitate development of reference location proxies. The behavior modeler 128 may also be configured to reference transaction information, and generate, based on reference locations and the transaction information, a spending density map, as described below in further detail with reference to FIG. 4. For example, the behavior modeler 128 may be configured to analyze, for each ID proxy, spending behaviors based on financial transactions associated with the corresponding payment card. Spending behaviors may include, for example, propensity to spend, propensity to spend in a particular industry, propensity to spend at a particular merchant, transaction frequency, transaction frequency in a particular industry or at a particular merchant, average amount spent during a specified period of time, average amount spent in a particular industry or at a particular merchant, propensity to spend at specific dates and/or times, and/or other behaviors.

The processing server 102 illustrated in FIG. 1 also includes a location predictor 130 and a port predictor 132. In embodiments, the processing server 102 may have, or utilize, only one of the two predictors 130, 132. Each predictor 130, 132 may be configured to determine an output used to facilitate strategic installation of one or more charging ports 106. The output may be based, for example, on one or more of a first set of transaction information, a second set of transaction information, reference locations, and a spending density map.

In embodiments, the location predictor 130 is configured to determine a target location for installation of a charging port 106, e.g., by using a spending density map. For example, the location predictor 130 may be, utilize, or include a nearest-neighbor model (e.g., a k-nearest-neighbor model) configured to identify a target location that has (or is associated with a geographic region that has) similar attributes as existing charging locations. The attributes, which may be represented on the density map, may include, for example, information associated with merchant locations and spending behaviors. Such spending behaviors may include, for example, indications of merchant locations, indications of transaction frequencies corresponding to merchant locations, indications of transaction frequencies corresponding to ID proxies, indications of amounts spent, indications of distances between reference locations and merchant locations and/or existing charging ports, and amounts of time that charging port customers spend at merchant locations.

In embodiments, the port predictor 132 may be configured to determine a target number of ports for a charging location. In embodiments, the port predictor 132 may utilize spending behavior information determined by the behavior modeler 128. That is, for example, the behavior modeler 128 may be configured to reference a set of transaction information, and determine a plurality of metrics associated with the set of transaction information, where the port predictor 132 is configured to use the plurality of metrics to determine the target number of ports for the charging location. In embodiments, the port predictor 132 may utilize predictive modeling, supply/demand analysis, and/or the like to determine a target number of ports for the charging location.

According to embodiments, various components of the operating environment 100, illustrated in FIG. 1, may be implemented on one or more computing devices. A computing device may include any type of computing device suitable for implementing embodiments of the disclosure. Examples of computing devices include specialized computing devices or general-purpose computing devices such “workstations,” “servers,” “laptops,” “desktops,” “tablet computers,” “hand-held devices,” and the like, all of which are contemplated within the scope of FIG. 1 with reference to various components of the operating environment 100.

In embodiments, a computing device includes a bus that, directly and/or indirectly, couples the following devices: a processor (e.g., the processor 118 depicted in FIG. 1), a memory (e.g., the memory 120 depicted in FIG. 1), an input/output (I/O) port, an I/O component (e.g., the I/O component 134 depicted in FIG. 1, which may be configured to receive communications from the payment processing system 114, for example), and a power supply. Any number of additional components, different components, and/or combinations of components may also be included in the computing device. The bus represents what may be one or more busses (such as, for example, an address bus, data bus, or combination thereof). Similarly, in embodiments, the computing device may include a number of processors, a number of memory components, a number of I/O ports, a number of I/O components, and/or a number of power supplies. Additionally any number of these components, or combinations thereof, may be distributed and/or duplicated across a number of computing devices.

In embodiments, the memory 120 includes computer-readable media in the form of volatile and/or nonvolatile memory and may be removable, nonremovable, or a combination thereof. Media examples include Random Access Memory (RAM); Read Only Memory (ROM); Electronically Erasable Programmable Read Only Memory (EEPROM); flash memory; optical or holographic media; magnetic cassettes, magnetic tape, magnetic disk storage or other magnetic storage devices; data transmissions; or any other medium that can be used to store information and can be accessed by a computing device such as, for example, quantum state memory, and the like.

In embodiments, the memory 120 stores computer-executable instructions for causing the processor 118 to implement aspects of embodiments of system components and/or to perform aspects of embodiments of methods and procedures discussed herein. Computer-executable instructions may include, for example, computer code, machine-useable instructions, and the like such as, for example, program components capable of being executed by one or more processors associated with a computing device. Examples of such program components include the database 122, the ID proxy component 124, the reference location component 126, the behavior modeler 128, the location predictor 130, and the port predictor 132. Program components may be programmed using any number of different programming environments, including various languages, development kits, frameworks, and/or the like. Some or all of the functionality contemplated herein may also be implemented in hardware and/or firmware.

The illustrative operating environment 100 shown in FIG. 1 is not intended to suggest any limitation as to the scope of use or functionality of embodiments of the present disclosure. Neither should it be interpreted as having any dependency or requirement related to any single component or combination of components illustrated therein. Additionally, any one or more of the components depicted in FIG. 1 may be, in embodiments, integrated with various ones of the other components depicted therein (and/or components not illustrated), all of which are considered to be within the ambit of the present disclosure. For example, the location predictor 130 may be integrated with the port predictor 132, and the processing server 102 may be integrated with the payment processing system 114.

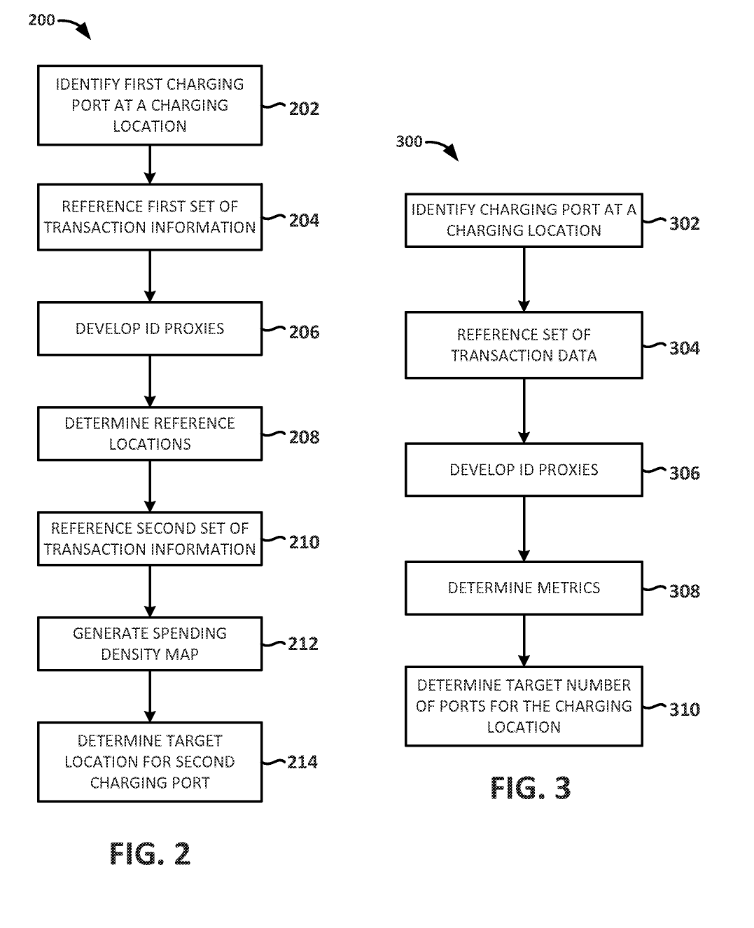

As described above, in embodiments, a processing server (e.g., the processing server 102 depicted in FIG. 1) may utilize transaction information associated with consumer payment card transactions to facilitate strategic installation of charging ports for electric vehicles. FIG. 2 depicts an illustrative method 200 for facilitating strategic installation of charging ports for electric vehicles using, for example, a processing server (e.g., the processing server 102 depicted in FIG. 1), an ID proxy component (e.g., the ID proxy component 124 depicted in FIG. 1), a reference location component (e.g., the reference location component 126 depicted in FIG. 1), a behavior modeler (e.g., the behavior modeler 128 depicted in FIG. 1), and a location predictor (e.g., the location predictor 130 depicted in FIG. 1).

As depicted in FIG. 2, embodiments of the illustrative method 200 include identifying a charging port at a charging location (block 202). A POS device may be disposed at the charging location. In embodiments, the charging location may include one, two, three, or more charging ports. A single POS device may facilitate transactions associated with a number of charging ports at the charging location. In other embodiments, each charging port, pair of charging ports, or the like, may have its own corresponding POS device. Charging ports may be identified using any number of different techniques and information. For example, the first charging port may be provided by a merchant that installs and manages charging ports. The first charging port may be identified based on a Merchant Category Code (MCC) that is associated with transactions originating at the POS at the charging location and that designates a merchant as one that installs and manages charging ports. In embodiments, a POS device may be identified as being associated with a charging port by referencing an associated MCC, and the charging location associated therewith may be provided by an acquirer (e.g., the acquirer 112 depicted in FIG. 1).

Embodiments of the method 200 further include referencing a first set of transaction information associated with the first charging port (block 204). For example, the POS device may be configured to extract payment card information from payment cards. The first set of transaction information may include information associated with a first set of payment card transactions, where each transaction of the first set of transactions originates at the charging location. As shown in FIG. 2, embodiments of the method include developing, based on the first set of transaction information, a number of ID proxies (block 206). Each ID proxy may correspond to one of the payment cards such that there is a one-to-one correspondence between the ID proxies and the payment cards. In a simplified example, the first set of transaction information may include the transaction information, listed in TABLE 1, associated with two charging ports, collected over a period of thirty days:

TABLE 1

| Card # | Amount | Merchant Name | Latitude | Longitude | Date | Location ID |
|---|---|---|---|---|---|---|
| A | $20 | Charge Point | 41.02372 | −73.71599579 | Jul. 31, 2014 | x |
| B | $10 | Charge Point | 41.02372 | −73.71599579 | Jul. 4, 2014 | x |
| C | $15 | Clipper Creek | 41.03461 | −73.77489471 | Jun. 30, 2014 | y |
| D | $5 | Clipper Creek | 41.03461 | −73.77489471 | Jul. 1, 2014 | y |

In this simplified example, the card numbers (A, B, C, and D) are used as ID proxies and, from the information, two charging ports, and corresponding charging locations may be identified.

Embodiments of the method 200 further include determining a number of reference locations, each corresponding to one of the ID proxies (block 208). As described above, a reference location may be, for example, a geographic location corresponding to an address associated with an ID proxy, a geographic region (e.g., a postal code) associated with the ID proxy, and/or the like. In embodiments, a reference location represents a location that is determined to be at least somewhat central to a radius of travel of the customer represented by the ID proxy. The radius of travel, and its center, may be estimated based on spending behaviors derived from transaction information associated with the ID proxy. The reference location may be, for example, a residential address of a cardholder of a payment card, a work address of the cardholder, a portion of the residential address, a portion of the work address, and/or the like. The reference location may include a residential postal code proxy, where determining the reference locations includes analyzing a set of spending behaviors associated with each of the ID proxies; and developing the residential postal code proxies based on the analyzed spending behaviors. As discussed previously, the reference location may be determined by obtaining the location from a card issuer (e.g., the card issuer 104), or by estimating the location based on spending behavior.

The method 200 further includes referencing a second set of transaction information (block 210). The second set of transaction information may include information associated with a second set of payment card transactions completed using the payment cards. In embodiments, each transaction of the second set of transactions originates at a location different than the charging location. The transaction information may include any number of different types of information such as, for example, transaction identifiers, transaction amounts, payment card identifiers (e.g., ID proxies), transaction dates and times, and/or the like. Thus, for the simplified example above, the second set of transaction information may include the transaction information in TABLE 2, which also includes the reference locations (here, residential postal code proxies) for each ID proxy:

TABLE 2

| | | | | | | Reference |
|---|---|---|---|---|---|---|
| Card # | Amount | Merchant Name | Industry | Latitude | Longitude | Location |
| A | $1,000 | Macy's | Store | 41.0237193 | −73.71599 | 10577 |
| A | $20 | Joe's Pizza | Food | 41.02367 | −73.723 | 10577 |
| A | $5 | McDonalds | Food | 41.02364 | −73.788 | 10577 |
| A | $500 | Macy's | Store | 41.0237193 | −73.71599 | 10577 |
| A | $40 | Shell | Fuel | 41.034334 | −73.34345 | 10577 |
| B | $700 | Macy's | Store | 41.0237193 | −73.71599 | 10583 |
| B | $50 | Whole Food | Groceries | 41.21 | −73.823 | 10583 |
| B | $50 | Shell | Fuel | 41.034334 | −73.34345 | 10583 |

As shown in FIG. 2, the method 200 includes generating a spending density map based on the reference locations and the second set of transaction information (block 212). The map may be, or include, a set of information, a visual representation of geographic regions, and/or the like. For example, the spending density map may be, or include, the table above and/or the illustrative map 400 depicted in FIG. 4 (and discussed in further detail below). The spending density map may include an indication, for each of the ID proxies, of a set of spending behaviors in a geographic region. According to embodiments, the set of spending behaviors may include an indication of a merchant location, an indication of a transaction frequency corresponding to a merchant location, an indication of a transaction frequency corresponding to an ID proxy, an indication of an amount spent, an indication of a distance between a reference location and a merchant location, an amount of time that a charging port customer spends at a merchant location, and/or the like. In embodiments, the spending density map includes representations of clusters of spending activity associated with the ID proxies.

As shown in FIG. 2, a final illustrative step of the method 200 includes determining, using the spending density map, a target location for installation of a second charging port (block 214). In embodiments, determining the target location for installation of the second charging port includes applying a location predictor (e.g., the location predictor 130 depicted in FIG. 1), which may include one or more predictive models. The predictive models may include, for example, a nearest-neighbor model. In embodiments, a nearest-neighbor model may be configured to identify a geographic location, identified by a latitudinal value and a longitudinal value, that optimizes a distance between reference locations and merchant locations, and a transaction frequency corresponding to merchant locations. The nearest-neighbor model may take, as input, a number of vectors, each vector corresponding to a geographic location (e.g., either a location having an existing charging port or a seed location). The vectors may include any number of various attributes including variables associated with transaction information, distances between reference locations and charging ports, and/or the like.

For the simplified example above, the second set of transaction information may be aggregated as shown below, in TABLE 3 and TABLE 4:

TABLE 3

| Store | Total Amount |
|---|---|
| Macy's | $2,200 |
| Shell | $90 |
| Whole Food | $50 |
| Joe's Pizza | $20 |
| McDonalds | $5 |

TABLE 4

| Zip | Total Amount |
|---|---|
| 10577 | $1,565 |
| 10583 | $800 |

That is, for example, the information could be aggregated based on merchant and/or geographical region, and a location predictor such as a nearest-neighbor model may be applied to the information to determine that a target location for installing a charging port would be near Macy's or within the 10577 postal code. Application of the nearest-neighbor model may include, for example, using the aggregated information above to select a seed location (e.g., near Macy's or within the 10577 postal code) and to compare attributes (e.g., transaction information) associated with the seed location to attributes associated with existing charging locations. In this manner, by selecting particular cluster sizes, attribute definitions, attribute weights, and the like, the predictor may be configured to account for differences in the amount of customer traffic at various merchants, the types of customers shopping at various merchants, charging distances associated with various customers, and/or the like.

As described above, in embodiments, a processing server (e.g., the processing server 102 depicted in FIG. 1) may utilize information associated with consumer payment card transactions to determine a target number of charging ports to install at a charging location. FIG. 3 depicts an illustrative method 300 for facilitating strategic installation of charging ports for electric vehicles using, for example, a processing server (e.g., the processing server 102 depicted in FIG. 1), an ID proxy component (e.g., the ID proxy component 124 depicted in FIG. 1), a reference location component (e.g., the reference location component 126 depicted in FIG. 1), a behavior modeler (e.g., the behavior modeler 128 depicted in FIG. 1), and a port predictor (e.g., the port predictor 132 depicted in FIG. 1).

As depicted in FIG. 3, embodiments of the illustrative method 300 include identifying a charging port at a charging location (block 302). A point-of-sale (POS) device may be associated with the charging port and may be configured to extract payment card information from payment cards that are capable of facilitating transactions originating at the POS device. Additionally, the POS device may be configured to generate a set of transaction information that includes the payment card information as well as other details of the transaction such as, for example, the amount to be paid, the date and time of the transaction, the location of the charging port, and/or the like. The method 300 further includes referencing the set of transaction information (block 304) and developing a number of ID proxies (block 306), each of the ID proxies corresponding to one of the payment cards such that there is a one-to-one correspondence between the ID proxies and the payment cards.

In embodiments, the method 300 further includes determining a number of metrics associated with the set of transaction information (block 308) and determining, based on the metrics, a target number of ports for the charging location (block 310). For example, in embodiments, a port predictor (e.g., the port predictor 132 depicted in FIG. 1) determines the target number of ports for the charging location by utilizing an exploratory data analysis (EDA) and/or a predictive model.

In a simplified example, the set of transaction information may include the information shown in TABLE 5:

TABLE 5

| Card # | Amount | Merchant Name | Latitude | Longitude | Date | Time |
|---|---|---|---|---|---|---|
| A | $20 | Charge Point | 41.02371979 | −73.71599579 | May 1, 2014 | 13:45 |
| B | $10 | Charge Point | 41.02371979 | −73.71599579 | May 1, 2014 | 13:15 |
| C | $15 | Charge Point | 41.02371979 | −73.71599579 | May 1, 2014 | 14:40 |
| B | $10 | Charge Point | 41.02371979 | −73.71599579 | May 3, 2014 | 13:15 |
| A | $25 | Charge Point | 41.02371979 | −73.71599579 | May 3, 2014 | 13:55 |
| D | $25 | Charge Point | 41.02371979 | −73.71599579 | May 3, 2014 | 14:50 |
| E | $25 | Charge Point | 41.02371979 | −73.71599579 | May 3, 2014 | 16:00 |

As shown, the set of transaction information may include card numbers used as ID proxies, an amount paid during each financial transaction, a name of the charging port merchant, a latitude and longitude corresponding to the charging location, a date of each transaction, and a time of each transaction. Brief inspection of this information may indicate that a number of customers, represented by ID proxies (i.e., card numbers) used the charging port around the same time on the same days. This might indicate, for example, that installing another charging port at the charging location may facilitate reaching a target number of ports, which may be determined to better satisfy the apparent demand. In actual implementation, the set of transaction information may be much larger and any number of more complicated data analysis techniques may be utilized to determine a target number of charging ports for a charging location.

In embodiments, the port predictor 132 determines the target number of ports by determining an equilibrium point representing an optimization of supply and demand associated with charging ports at the charging location. To achieve this, the port predictor may determine a supply curve and a demand curve and identify the intersection of the two curves as the equilibrium point. In embodiments, the equilibrium point may be determined by aggregating transaction information and analyzing various metrics such as, for example, average amount spent at a charging location, time between charges, number of unique transactions per time period, and/or the like. In embodiments, the port predictor 132 may further include a predictive model such as a nearest-neighbor model, a machine-learning model, and/or the like.

In embodiments, determining the demand for charging ports at a charging location may include analyzing additional information such as, for example, transaction information associated with neighboring merchants. In this manner, information associated with spending behaviors in an area around the charging location may be analyzed to predict the number of additional charging port customers that may be serviced by the installation of additional charging ports at a charging location. For example, a spending density map may be utilized for determining a target number of charging ports for a charging location. Embodiments of aspects of the techniques described herein for determining a target location for installation of an additional charging port may be utilized and/or modified to facilitate assessing the demand for charging ports in a particular spending center. Any number of different techniques, processes, types of information, and the like may be utilized in determining demand, optimizing the supply/demand equilibrium, and/or the like.

As explained above, embodiments may include a behavior modeler (e.g., the behavior modeler 128 depicted in FIG. 1) that generates a spending density map for use by a predictor in determining an output that facilitates strategic installation of a charging port. FIG. 4 is a conceptual diagram depicting an illustrative spending density map 400 that may be used, for example, to determine a target location for installation of an additional charging port. As shown in FIG. 4, the illustrative spending density map 400 includes representations of a number of geographic regions 402-414. The geographic regions 402-414 may represent actual geographic regions delineated according to postal codes, city lines, shopping districts, and/or any number of other criteria. For example, the geographic regions 402-414 may correspond to geographic centroids, spending centroids, and/or the like, as described in U.S. Publication No. 2014/0180767, to Villars, entitled “METHOD AND SYSTEM FOR ASSIGNING SPENDING BEHAVIORS TO GEOGRAPHIC AREAS,” filed on Dec. 20, 2012.

The map 400 also depicts a number of reference locations 416-428. As described above, each reference location 416-428 may correspond to an ID proxy associated with a payment card. The reference locations 416-428 may represent, e.g., addresses, portions of addresses, postal codes, and/or the like. As shown in FIG. 4, the spending density map 400 may also depict a number of merchants 430-460, indicated by rectangles. In the spending density map 400, the location of each rectangle represents the geographic location of the corresponding merchant 430-460. The relative size of each rectangle indicates the relative amount of spending activity that occurred at the corresponding merchant 430-460 during a specified period of time. For example, it can be ascertained, by comparing the relative sizes of the rectangles, that the merchant 454 received significantly more spending activity (which may be quantified, e.g., by average payment card revenue received over the particular period of time) than the merchant 450.

Additionally, in the spending density map 400 depicted in FIG. 4, the relative amount of shading of each rectangle 430-460 indicates the relative amount of activity from customers of interest (e.g., the ID proxies associated with transaction information being analyzed). For example, the relative shading of the rectangles representing merchants 452 and 454 may indicate that, for the specified period of time, the set of transactions originating at the merchant 452 involved fewer of the ID proxies corresponding to reference locations 416-428 than the set of transactions originating at the merchant 454 over the same specified period of time. According to embodiments, any of the metrics indicated by various features of the density spending map 400 may be defined in any number of ways, to accommodate any number of techniques and/or data storage schemes, and/or the like. For example, in embodiments, the spending activity measures indicated by the size and shading of the rectangles may be normalized to account for merchants that inherently receive more activity than other merchants (e.g., grocery stores as opposed to antique lamp shops), adjusted to account for average amounts of time that consumers spend at various types of merchant locations (e.g., fitness clubs as opposed to fast food retailers), and/or the like.

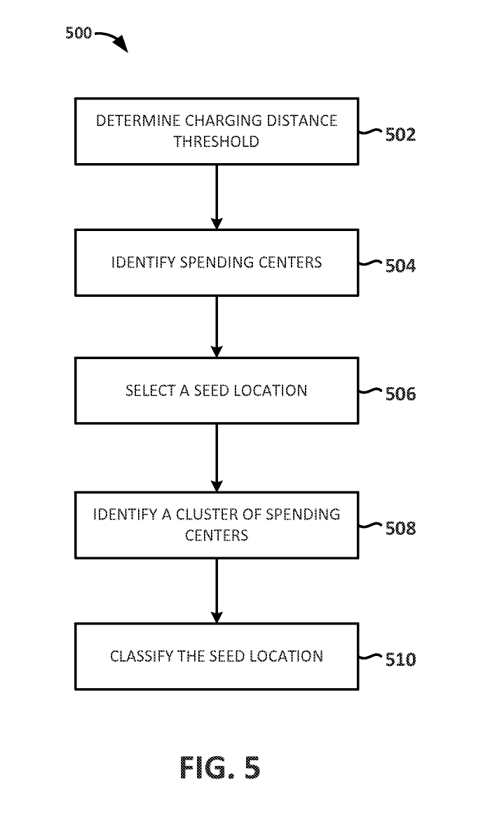

The spending density map 400 is further used to illustrate concepts explained in the description of FIG. 5 below. The spending density map 400 shown in FIG. 4 is intended as a conceptual representation to aid in the reader's understanding of various aspects of embodiments of the methods and systems described herein, and is not intended to suggest any limitation as to the scope of use or functionality of embodiments of the present disclosure. Neither should it be interpreted as having any dependency or requirement related to any single component or combination of components illustrated therein. According to various embodiments, spending density maps may be configured in any number of ways and may be configured to represent any number of different types of information, metrics, relationships, and/or the like.

Additional, alternative and overlapping aspects of embodiments of the methods disclosed herein for facilitating strategic installation of charging ports for electric vehicles are illustrated in FIG. 5. As described above, a processing server (e.g., the processing server 102 depicted in FIG. 1) may utilize information associated with consumer spending behaviors (derived from transaction information) to determine a target location for installation of additional charging ports. FIG. 5 is a flow diagram depicting an illustrative method 500 of using a nearest-neighbor technique to determine a target location for installation of a charging port.

As shown in FIG. 5, embodiments of the method 500 include determining a charging distance threshold (block 502). The charging distance threshold may include a minimum distance between a reference location and a charging port (or seed location), and may represent an average minimum distance that a customer will travel away from a reference location (e.g., the customer's residence or place of work) before utilizing a charging port. The charging distance threshold may be determined by analyzing spending behavior associated with a number of ID proxies, referencing research literature, conducting surveys, calculating average electric vehicle battery life, and/or the like. In embodiments, the charging distance threshold may be determined for each application of the nearest-neighbor model, or may be re-used for a number of applications thereof. Additionally, in embodiments, unique charging distance thresholds may be assigned to different ID proxies to account for varying attributes such as, for example, battery life, frequency of charging, charging distances, and/or the like.

As depicted in FIG. 5, embodiments of the illustrative method 500 further include identifying spending centers, where each spending center corresponds to one or more of a number of ID proxies (block 504). Spending centers may refer to geographic areas associated with groups of merchants, spending activity, and/or the like. For example, with reference to FIG. 4, each of the geographic regions 402-414 may correspond to a spending center. Alternatively, for example, a first spending center may be identified as a region that includes merchants 450, 452, 454, 456, 458, and 460, while a second spending center may be identified as a region that includes merchants 430, 432, and 434. In embodiments, the definition of spending centers may vary between implementations and may, for example, be modified to accommodate optimization factors learned from previous applications of a nearest-neighbor model.

As shown in FIG. 5, embodiments of the illustrative method 500 include selecting a seed location (block 506). The selected seed location is the data point that the nearest-neighbor model is used to test (e.g., classify). In embodiments, the seed location may include a location selected based on information included in a spending density map. That is, for example, a seed location 462 may be selected based on its physical proximity to a number of merchants 450, 452, 454, 456, 458, and 460 within the second spending center. According to embodiments, any number of different criteria and/or, considerations may be utilized for selecting a seed location.

Embodiments of the method 500 further include identifying a cluster of spending centers (block 508). According to embodiments, a cluster of spending centers may include any number of spending centers, where the number of spending centers in the cluster may be selected as the “k” parameter of the nearest-neighbor model. The selection of the number of spending centers in a cluster may be guided by optimization processes, criteria, and/or the like. In embodiments, the cluster may be selected such that, within the cluster, each spending center (or merchant) is associated with activity corresponding to an ID proxy that has an associated reference location for which a charging distance (i.e., a distance between the reference location and either a seed location 462 or an existing charging port 464) is greater than the charging distance threshold. For example, as shown in FIG. 4, the charging distance 468 may be less than a charging distance threshold, whereas the charging distances 470, 472, and 474 may be greater than the charging distance threshold. Additionally, in embodiments, charging distance may be defined according to an actual driving route, a straight-line path (as shown in FIG. 4), and/or the like, and may be configured to incorporate speed limits, traffic signals, and/or the like.

As shown in FIG. 5, the illustrative method 500 further includes classifying the seed location 462 by applying a nearest-neighbor model (block 510). In embodiments, the nearest-neighbor model may be utilized to determine whether the seed location 462 represents a geographic location (identified, for example, by a latitude and longitude) that is located in a spending center and balances charging distances with spending activity. The nearest-neighbor model may be configured to operate upon vectors corresponding to locations and having attributes that include, for example, charging distances (or averages thereof) associated with ID proxies of interest, latitude, longitude, merchant identifiers, measures of spending activity, and/or the like. In this manner, the nearest-neighbor model may classify the seed location 462 as a target location for installation of an additional charging port.

According to embodiments, the nearest-neighbor model is configured to identify target locations for installation of charging ports that would be likely to be convenient to consumers and be located in regions in which their use would be maximized. That is, for example, a mall might be selected as a seed location based on an analysis that suggests that a number of customers that drive electric cars frequent the mall and neighboring stores. However, it may be the case that a majority of the electric car users being considered live near the mall and would not be motivated to charge their vehicles during a trip to the mall because it is not far enough from their homes to justify the expense. Thus, in embodiments, a weight may be added to the attribute characterizing charging distance so as to prevent identification of a target location for installation of a charging port where the demand is likely to be low.

While embodiments of the present disclosure are described with specificity, the description itself is not intended to limit the scope of this patent. Thus, the inventors have contemplated that the claimed disclosure might also be embodied in other ways, to include different steps or features, or combinations of steps or features similar to the ones described in this document, in conjunction with other technologies. For example, various aspects of processes described herein may be augmented by using machine-learning techniques to optimize aspects of data collection, classification, prediction, and/or the like.

The following is claimed:

1. A system for facilitating strategic installation of charging ports for electric vehicles, the system comprising:
a processing server configured to receive a first set of transaction information from a payment processing system, wherein the payment processing system is configured to receive the first set of transaction information from a point-of-sale (POS) device disposed at a charging location and associated with a first charging port at the charging location, the POS device being configured to extract payment card information from payment cards and to generate the first set of transaction information that includes the payment card information, wherein each payment card is capable of facilitating a transaction originating at the POS device, the processing server comprising:
a storage component, wherein the storage component contains (1) the first set of transaction information, and (2) a second set of transaction information, wherein the second set of transaction information comprises information associated with a second set of transactions completed using the payment cards, wherein each transaction of the second set of transactions originates at a location different from the first charging location;
an identification (ID) proxy component configured to develop ID proxies, wherein each of the ID proxies corresponds to one of the payment cards such that there is a one-to-one correspondence between the ID proxies and the payment cards;
a reference location component configured to determine reference locations, each corresponding to one of the ID proxies; and
a predictor configured to determine an output used to facilitate strategic installation of a second charging port, wherein the output is based on at least one of the first set of transaction information, the second set of transaction information, and the reference locations.

2. The system of claim 1, wherein the predictor comprises a location predictor configured to determine a target location for installation of the second charging port.

3. The system of claim 2, further comprising:
a behavior modeler configured to (1) reference the second set of transaction information, and (2) generate, based on the reference locations and the second set of transaction information, a spending density map;
wherein the location predictor is configured to use the spending density map to determine the target location for installation of the second charging port.

4. The system of claim 1, wherein the predictor comprises a port predictor configured to determine a target number of ports for the charging location, wherein installation of the second charging port at the charging location facilitates reaching the target number of ports for the charging location.

5. The system of claim 4, further comprising a behavior modeler configured to (1) reference the first set of transaction information, and (2) determine metrics associated with the first set of transaction information, wherein the port predictor is configured to use the metrics to determine the target number of ports for the charging location.

6. The system of claim 1, wherein the reference location component is configured to determine the reference locations by receiving residence locations from a payment card issuer, wherein each of the residence locations comprises at least a portion of an address of a cardholder.

7. The system of claim 1, wherein the reference location component is configured to determine the reference locations by (1) analyzing a set of spending behaviors associated with each of the ID proxies, and (2) developing reference location proxies based on the analyzed spending behaviors.

8. A method for facilitating strategic installation of charging ports for electric vehicles, the method comprising:
identifying a first charging port at a charging location, wherein a point-of-sale (POS) device is disposed at the charging location and is associated with the first charging port, the POS device being configured to extract payment card information from payment cards and to generate a first set of transaction information that includes the payment card information, wherein each payment card is capable of facilitating a transaction originating at the POS device;
referencing the first set of transaction information;
developing identification (ID) proxies, wherein each of the ID proxies corresponds to one of the payment cards such that there is a one-to-one correspondence between the ID proxies and the payment cards;
determining reference locations, each corresponding to one of the ID proxies;
referencing a second set of transaction information, wherein the second set of transaction information comprises information associated with a second set of transactions completed using the payment cards, wherein each transaction of the second set of transactions originates at a location different from the charging location;
generating, based on the reference locations and the second set of transaction information, a spending density map comprising indications, for each of the ID proxies, of spending behaviors in a geographic region; and
determining, using the spending density map, a target location for installation of a second charging port.

9. The method of claim 8, further comprising:
determining metrics associated with the first set of transaction information; and
determining, based on the metrics, a target number of ports for the charging location.

10. The method of claim 8, wherein determining the reference locations comprises receiving residence locations from a payment card issuer, wherein each of the residence locations comprises at least a portion of an address of a cardholder.

11. The method of claim 8, the reference locations comprising residential postal code proxies, wherein determining the reference locations comprises:
analyzing the spending behaviors associated with each of the ID proxies; and
developing the residential postal code proxies based on the analyzed spending behaviors.

12. The method of claim 8, wherein the spending behaviors comprise at least one of an indication of a merchant location, an indication of a transaction frequency corresponding to a merchant location, an indication of a transaction frequency corresponding to an ID proxy, an indication of an amount spent corresponding to a transaction, an indication of a distance between one of the reference locations and a merchant location, and an amount of time that a charging port customer, represented by an ID proxy, spends at a merchant location.

13. The method of claim 8, wherein determining the target location for installation of the second charging port comprises applying a predictive model.

14. The method of claim 13, wherein the predictive model comprises a nearest-neighbor model.

15. The method of claim 14, wherein applying the nearest-neighbor model comprises:
determine a charging distance threshold, the charging distance threshold comprising an average minimum charging distance, wherein a charging distance comprises a distance between a reference location and a charging port;
identifying a plurality of spending centers, wherein each of the plurality of spending centers corresponds to one or more of the ID proxies;
selecting a seed location associated with a first spending center, wherein the seed location comprises a selected location on the spending density map;
identifying a cluster of spending centers, the cluster of spending centers including the first spending center and at least one second spending center, the at least one second spending center including an existing charging port, wherein each spending center corresponds to at least one charging distance that is greater than the charging distance threshold; and
classifying the seed location as the target location for installation of the second charging port by analyzing attributes associated with each spending center, the attributes comprising at least a portion of the second set of transaction information and charging distances.

16. The method of claim 15, further comprising assigning weights to the charging distances.

17. A system for facilitating strategic installation of charging ports for electric vehicles, the system comprising:
a retention device having executable instructions embodied thereon; and
a processor configured to execute instructions to instantiate components, the components comprising:
an input/output (I/O) component configured to receive a first set of transaction information from a point-of-sale (POS) device, the POS device being associated with a first charging port at a charging location, the POS device being configured to extract payment card information from payment cards and to generate the set of transaction information that includes the payment card information, wherein each payment card is capable of facilitating a transaction originating at the POS device;
a storage component configured to store (1) the first set of transaction information, and (2) a second set of transaction information, wherein the second set of transaction information comprises information associated with a second set of transactions completed using the payment cards, wherein each transaction of the second set of transactions originates at a location different from the charging location;
an identification (ID) proxy component configured to develop ID proxies, wherein each of the ID proxies corresponds to one of the payment cards such that there is a one-to-one correspondence between the ID proxies and the payment cards;
a reference location component configured to determine reference locations, each corresponding to one of the ID proxies; and
a predictor configured to determine an output used to facilitate strategic installation of a second charging port, wherein the output is based on at least one of the first set of transaction information, the second set of transaction information, and the reference locations.

18. The system of claim 18, wherein the predictor comprises at least one of a location predictor configured to determine a target location for installation of the second charging port and a port predictor configured to determine a target number of ports for the charging location, wherein installation of the second charging port at the charging location facilitates reaching the target number of ports for the charging location.

19. A method for facilitating strategic installation of charging ports for electric vehicles, the method comprising:
identifying a charging port, wherein a point-of-sale (POS) device is associated with the charging port, the POS device being configured to extract payment card information from payment cards and to generate a set of transaction information that includes the payment card information, wherein each payment card is capable of facilitating a transaction originating at the POS device;
referencing the set of transaction information;
developing identification (ID) proxies, wherein each of the ID proxies corresponds to one of the payment cards such that there is a one-to-one correspondence between the ID proxies and the payment cards;
determining a plurality of metrics associated with the set of transaction information; and
determining, based on the plurality of metrics, a target number of ports for the charging location.

20. The method of claim 19, wherein determining the target number of ports comprises utilizing at least one of an exploratory data analysis (EDA) and a predictive model.
